(19) United States
(12) Patent Application Publication
(10) Pub. No.: US 2003/0028482 A1
(43) Pub. Date: Feb. 6, 2003

(54) Method and apparatus for accounting and billing for telecommunicatively rendered services

(76) Inventors: Carl S. Burak, Atlantic Beach, FL (US); Karl O.W. Steen, Ponte Vedra Beach, FL (US)

Correspondence Address: Charles N. Quinn, Esq., Fox, Rothschild, O'Brien & Frankel, LLP, 2000 Market Street, 10th Floor, Philadelphia, PA, 19103, US

(21) Appl. No.: 10/189,792

(22) Filed: Jul. 3, 2002

Related U.S. Application Data
(60) Provisional application No. 60/303,047, filed on Jul. 5, 2001.

(51) Int. Cl. G06F 17/60

(52) U.S. Cl. 705/40

(57) ABSTRACT

A method preferably implemented using a digital computer provides payments to a provider rendering service individually and sequentially to a plurality of patients via telephone based on the individual time duration for performance of the telephone consultation services.

### BACKGROUND OF THE INVENTION

1. Field of the Invention

This invention relates to methods and apparatus for accounting and billing of patients and/or third party guarantors for telecommunicatively provided services rendered from a remote locale.

2. Description of the Prior Art

Healthcare providers, namely physicians, and other professional service providers are under pressure from third party payors such as health maintenance organizations and insurers. Healthcare providers such as physicians find that their time with patients is limited. Telephone contact is necessary in many cases but telephone contact time may be limited by other time constraints and revenue generating activities. Healthcare providers such as physicians have found that billing for telephone-based care and consultation theoretically is feasible but largely impractical due to the relatively short duration of such telephone consultations. As a result patients lose out since the patients experience less telephone consultation time.

### SUMMARY OF THE INVENTION

This invention is premised on the use of preferably G-3 wireless web technology enabling healthcare providers, other physicians and other service providing professionals to improve the delivery of healthcare services via telephone and worldwide web technology. In accordance with the invention, a healthcare provider or other service provider need only carry a web-enabled cellular telephone to access patient data and return calls to the patient. Billing for such consultation is automatic with the method and apparatus of the invention.

The invention features a minimized amount of patient data being stored preferably on media accessible via the worldwide web. Utilizing the invention, patients call and access a local number to register the patient's requirement for a call from the healthcare provider or other service rendering professional. Patient calls are resultantly queued according to a preestablished priority. The healthcare provider may view the queued calls via a dedicated website. The healthcare provider may elect to make a return call which may be automatically dialed. Software aspects of the invention capture and record the length of the call and calculate charges to be associated with the call. The charge data go electronically to an automated merchant billing sequence without the use or generation of any paper.

The invention presents multiple payment options to the patient including credit card payment, direct fund transfers or automatic invoicing to the patient or a third party payor, optionally at special rates.

Desirably, the patient makes a choice of payment from the options available at the time of enrollment. The patient may self-enroll while present in the health care provider's office.

In one implementation the invention includes security precautions such as secured links and personal identification numbers for users. Calls are documented providing an additional measure of safety and security. Healthcare providers may add dictation of clinical notes which may be placed on a wave file which may be stored, transmitted by facsimile or e-mail as desired. The invention further features visibility by the healthcare provider of all transactions and billing. The invention further desirably provides text messaging advising the healthcare provider of all calls. Utilization of the invention eliminates an answering service for the healthcare provider. Worldwide web or voice delivery, or both, of relevant medical data may be made while the healthcare provider is waiting for a call. The healthcare provider may be prompted with the last interaction according to the system as implemented.

In accordance with this invention, there is low or even no entry cost for a given healthcare provider with minimal additional burden on the healthcare provider's staff. The invention has applicability to a multiplicity of medical specialties and other professional disciplines. The invention facilitates healthcare provider access to defined clinical resources and resultantly makes possible twenty-four hour a day, seven-day a week delivery of healthcare at any locale.

An important feature for the healthcare provider is that the invention provides automatic prioritization and queuing of the incoming patient calls. This minimizes lost time for the healthcare professional and maximizes the value of the healthcare professional's time to patients. This further reduces unnecessary office visits by patients and improves the odds of a patient getting through to the healthcare provider in a real emergency.

The invention permits the healthcare provider to generate significant revenue where revenue did not exist before, namely in telephone consultation. The invention further enables healthcare providers to follow more patients, for a longer time, at a reduced cost on a per patient basis. The invention provides a dramatic, effective and simple implementation of a highly complex accounting, timekeeping and billing problem. As a result, for some medical specialists there is a reduced need for physical office space from which to practice.

The invention further envisions extension of the concepts to provide low cost video for billable telemedicine where medical advice will be rendered via teleconference connections. The invention further embraces instant referrals within the medical care system, the storage and viewing of patient medical history over the worldwide web and Bluetooth or Palm. computer links to telemetry appliances for routine monitoring of patient vital signs while the patient is at home.

In one of its aspects this invention provides a method, accomplished desirably with the aid of one or more digital computers, for billing and hence furnishing a stream of payments to a provider rendering services individually and sequentially to a plurality of patients via telephone, based on the individual time duration of performance of the services.

In another of its aspects this invention provides a data collecting, correlating and processing method for furnishing payments to providers rendering services individually and sequentially to patients via telecommunication means, based on individual time service performance, by debits to third-party guarantor-payors.

In yet another of its aspects this invention provides a method for accounting and billing for telecommunicatively rendered services provided from a remote locale where the method may commence with collecting, collating and correlating, into a machine readable digital database, individual data for a plurality of patients who may individually seek personal services, with the data including telecommunicative contact specifications, one or more payment modes and payment guarantor account numbers.

The method may proceed, in response to an individual putative patient-generated request for service, by digitally comparing data provided by a requesting putative patient to the collected and collated data in order to determine whether the asserted patient's data is within the database. The method may then proceed, upon finding data for a putative patient in the database, by placing a telecommunicative request for service from the patient into a queue according to at least one pre-selected criterion.

The method may further proceed with telecommunicatively connecting the patient with a service provider by whom the patient has requested service be provided.

Upon conclusion of provision of the service, the method may proceed to update the database to reflect provision of the service and may further proceed with computing a charge for the service rendered, with the charge being computed in accordance with instructions from the provider. The method may then proceed with updating the database to reflect the generated charge for the patient to whom the services were rendered, and may still further proceed with telecommunicatively furnishing the charge to a payment guarantor for the patient as identified in the database and with updating the database to reflect the degree or amount of satisfaction in the form of payment for the generated charge by the patient's guarantor upon receipt of payment from such guarantor.

In yet another of its aspects this invention may provide a method for accounting and billing for telephone and other remote telecommunicatively furnished services where the method may include as one of its initial steps that of collecting and collating data for a patient user to whom the services are to be rendered, with the data including telephone and/or Internet contact specifications, payment mode(s), account numbers and, optionally, patient insurance payment information, and further independently and optionally patient service history and background information. A further step of the method involves comparing data provided by the requesting patient to the collected and collated data to determine whether the requesting and asserting patient is legitimate in response to an asserted patient request for service. In the course of performance of the method, in the event the patient is determined to non-legitimate, the method may abandon the current request for service and commence processing a subsequent request for service.

In further practice of this method in this aspect of the invention, upon verification of the asserting patient as being legitimate, as a result of the data comparison noted above satisfying at least one pre-selected criterion, the method proceeds by placing a marker respecting the patient's call in a queue together with markers for other patient calls according to at least one pre-selected criterion.

The method may then proceed to determine whether the request for service may be satisfied without voice communication between the patient, which has been determined to be legitimate, and the desired provider. In such event the method may provide the requested service for the patient since provider voice communication is not required.

In this aspect of the invention the method may then proceed with telecommunicatively attempting to connect the patient with the service provider of whom the patient has requested service be provided via such telecommunicative means. Upon a failure to telecommunicatively connect the patient with the requested service provider, the method may proceed to mark a record to memorialize the fact of attempted but unsuccessful communication and may commence to process the next request for service. However, upon successful telecommunicative connection of the patient with a requested service provider, the method desirably proceeds to maintain the connection for the duration of the session as may be needed for the desired service to be provided.

In this aspect of the invention, upon completion of the service provision activity the method proceeds to update data for the patient to reflect provision of the service and computes a charge for the service rendered during the most recently concluded session in accordance with instructions previously specified by the service provider. The method then proceeds to determine, according to pre-specified criteria, whether the services provided during the most recently concluded session are chargeable; if the services are determined to be non-chargeable, the method commences with the next request for service. However, if the services provided during the most recently concluded session are determined to be chargeable, the method proceeds to elicit provider input as to whether a charge should be issued for such most recently provided services. In the event a charge is to be issued for such most recently provided services, the method may proceed to generate the charge according to pre-selected criteria, which may include the length of time the patient and provider were in telecommunicative connection, and may place the generated charge data into the database and marked for the patient for whom the services were rendered.

The method may also embrace generating a display of patient medical history from the database and furnishing the display to a service provider via a web-enabled telephone.

The method may yet further embrace generating a display of visually discernable information corresponding to the queued calls in accordance with a pre-established call priority scheme for selection by the provider.

The method may yet further embrace making a call to a patient as selected by the service provider, for example by dialing a number corresponding to the queued call as selected by the provider.

Desirably, lengths of completed ones of the calls as initiated by the provider are recorded and charges are computed for each of the completed calls, with such charge information being entered into the database for the respective patients to whom the services were rendered.

In yet another of its aspects the method may embrace recording a service provider's voice-generated clinical notes and instructions relevant to a given patient and entering those into a database and indexed as against the relevant patient.

The method may further embrace the step of providing a display of calls received, calls made and billings generated as a result of such calls for inspection by the provider.

The method may yet further embrace the step of telecommunicatively ordering prescription medication for a patient at a locale remote from the provider ii response to a digital input from the provider made by a telephone.

The method may still yet further embrace the step of telemetrically receiving patient real-time medical information and displaying the same to a service provider via a web-enabled telephone or other telecommunicative means.

The invention facilitates and automates reimbursement for telephone and worldwide web based delivery of professional medical services, provides automated clinical and professional notetaking capability, documents consultative calls by duration, time and patient automatically establishes that priority of patient calls to be returned by the healthcare professional rendering this service, may provide automated prescription service actuable by the attending healthcare professional and permits the patient to link to other databases during the same consultation call.

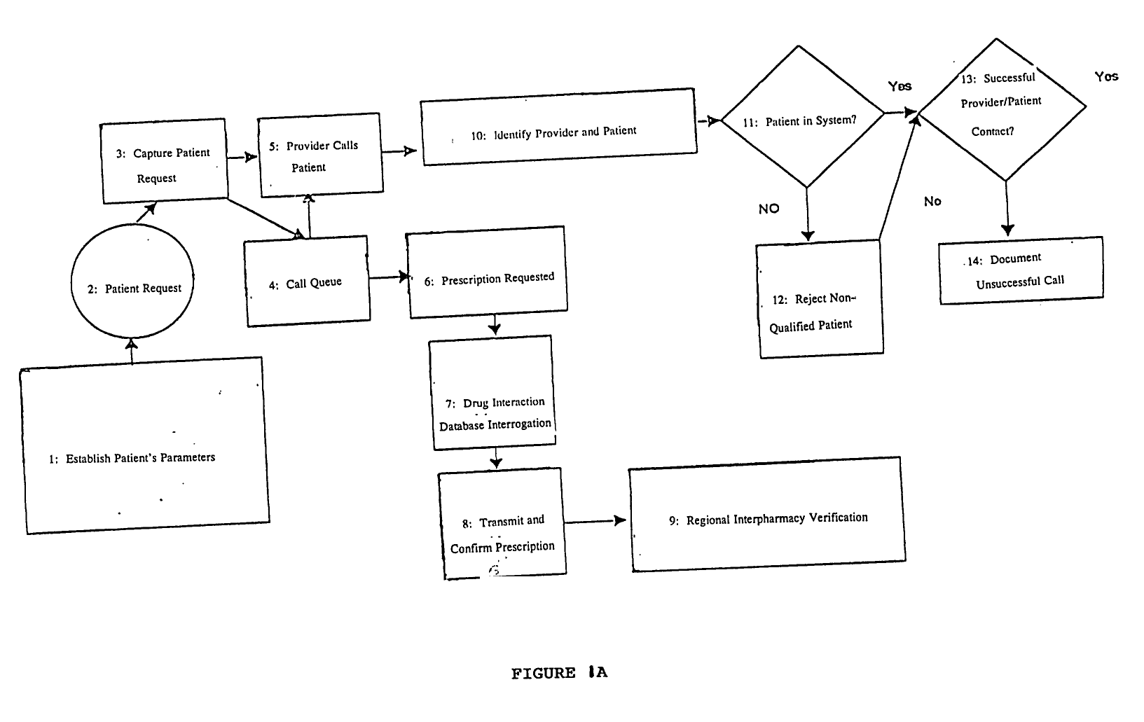

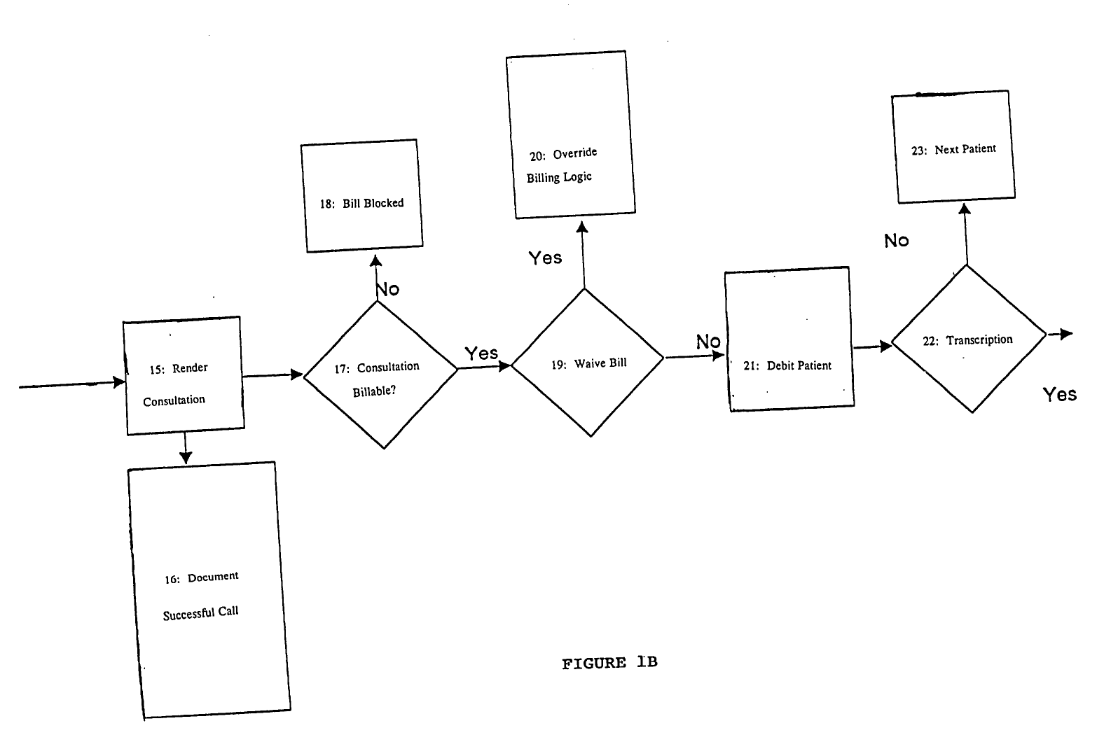

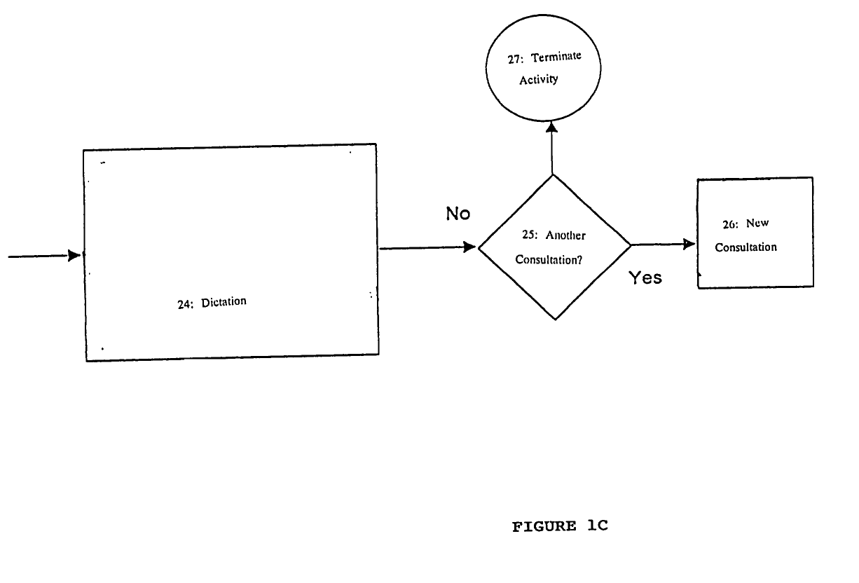

FIG. 1, appearing on three sheets in three parts as FIGS. 1A, 1B and 1C, is a flow chart diagram of the best mode known for practicing the method of the invention.

### DESCRIPTION OF THE PREFERRED EMBODIMENTS AND BEST MODE KNOWN FOR PRACTICE OF THE INVENTION

Referring to the drawing in general to FIG. 1A in particular, before the method and apparatus of the invention may function, a given patient must agree to participate in the process. As part of that agreement the patient must select the payment method for telephone consultation and the same or perhaps a different payment method for Internet consultation with the healthcare professional. The invention in its current implementation as described herein, it is assumed that the patient has payment responsibility and that there is no insurance interaction between the attending healthcare provider, the system of the invention and any insurance company from which the patient holds a policy. However, it is to be understood that the invention may generate insurance documentation for a given patient at the patient's request. All of these preconditions are grouped together in box 1 which is appropriately labeled “Establish Patient's Parameters” in FIG. 1A.

The method of the invention is initiated when a patient requests a call from the healthcare professional for medical service consultation. This initiation of the method is indicated by the arrow in FIG. 1 and by circle 2 labeled “Patient Request”.

The patient's request for medical service made by telephone or Internet is captured by the staff attendant to the process as indicated in block 3 labeled “Capture Patient Request”.

If the healthcare professional is busy with a patient, speaking on another call or otherwise occupied, the request for service made by the patient and represented by the telephone call is placed into a queue according to a predetermined algorithm. This procedure is indicated in box 4 in FIG. 1A labeled “Call Queue.”. However, if the attending healthcare professional is available the attending healthcare professional calls the patient via the system server which preferably automatically dials the patient's telephone number. Box 5 includes a descriptive label “Provider Calls Patient” for these aspects of the method.

Alternatively, if the patient was calling for refill of a prescription, the system detects this and invokes a prescription database portion of the system. Box 6 includes the descriptive label “Prescription Requested” for these aspects of the method.

Before the prescription is approved for refilling, the system interrogates a drug-drug interaction database to compare the drug for which the patient has requested the prescription be refilled with other medications indicated to be available to and in use by the patient by data in the drug-drug interaction database. Box 7 includes the descriptive label “Drug Interaction Database Interrogation” for these aspects of the method.

If the interrogation of the drug-drug interaction database indicates there to be no problem with the patient taking the drug for which the prescription refill has been requested, the system proceeds to automatically transmit the prescription order to a pharmacy, which has been identified as the pharmacy of choice for the calling patient, and requires a return confirmation that the prescription order has been received from the dispensing pharmacy. Box 8 includes the descriptive label “Transmit and Confirm Prescription” for these aspects of the method.

The system then preferably proceeds to interrogate a regional interpharmacy database to assure that the prescription is not a duplicate and to check again to be sure that there will be no adverse reaction by the patient to the drug which is the subject of the prescription being refilled. Box 9 includes the descriptive label “Regional Interpharmacy Verification” for these aspects of the method.

Returning to the path from boxes 4 to 5 in FIG. 1A, once the attending healthcare professional calls the requesting patient via the system server autodialing the patient's telephone number or connecting with the patient's web-based computer, when the attending healthcare professional instructs the system server to establish a voice connection with the requesting patient, the system server identifies the attending healthcare professional via the healthcare professional's DIN number and the attending healthcare professional's personal identification number and identifies the requesting patient via the requesting patient's telephone number together with demographic data which may be in the system database. Box 10 includes the descriptive label “Identify Provider and Patient” for these aspects of the method.

The system server proceeds to attempt to match the telephone number of the requesting patient having made the telephone call into the system with a telephone number stored in the system database on the system server. Decision box 11 includes the descriptive label “Patient in System” for this aspect of the method.

In the event the system server is unable to correlate the telephone number from which the requesting patient has made the telephone call seeking to contact the attending healthcare professional, the system server notes that the patient is not currently recognized as a member of the system, disconnects the call and initiates a new patient sequence by returning to box 5. Box 12 includes the descriptive label “Reject Non-Qualified Patient” for these aspects of the method.

If the system server was able to correlate the telephone number from which the requesting patient made the telephone call seeking to contact the attending healthcare professional, with a telephone number stored in the system database, the system proceeds to attempt to call the requesting patient on behalf of the attending healthcare consultative professional. If the attempt is successful and a connection is established between the attending healthcare professional and the requesting patient, either via telephone or over the worldwide web, the attending healthcare professional may proceed to deliver the medical healthcare services via telephone to the requesting patient. Decision box 13 includes the descriptive label “Successful Provider/Patient Contact” as indicating whether the connection was successfully made. In the event the connection was not successfully made, a record of the attempt to make the connection is established whereupon the system proceeds to retrieve the next call which may be present in the queue according to box 4. Box 14 includes the descriptive label “Document Unsuccessful Call” for the aspect of documenting the attempted but unsuccessful call from the attending healthcare professional to the requesting patient.

Upon successful connection of the attending healthcare professional with the requesting patient as indicated by decision box 13, the attending healthcare professional proceeds to deliver the requested consultative services to the patient. Upon completion of delivery of the services, the attending healthcare professional terminates the telephone call or worldwide web contact. Box 15 includes the descriptive label for the aspect of completing successful delivery of the required consultative services by the attending healthcare professional.

Once the attending healthcare professional has completed delivery of the medical care consultative services to the requesting patient via telephone or over the Internet, the system server proceeds to update the system database by documenting the call as to duration, date, time and requesting patient, calculates the service charges for the call in accordance with the attending healthcare professional's previously established instructions and updates the data file for the requesting patient to indicate that consultative services were rendered, the duration of the consultative services and the time and date those consultative services were rendered by the attending healthcare professional. Box 16 includes the descriptive label “Document Successful Call” for these aspects of the method.

The system then proceeds to determine whether the call made to connect the attending healthcare professional with the requesting patient is a billable call in accordance with business use rules previously established and resident on the system server. In the event the system server determines the call to be non-billable, an appropriate flag is set so that the system server will not generate a bill or undertake any further activity to obtain revenue based on that call. Decision box 17 includes the descriptive label “Consultation Billable” for this decisional aspects of the method; box 18 includes the descriptive label “Bill Blocked” indicating that no bill is generated for the consultative call which has been determined to be now billable.

In the event the logic represented by decision box 17 has determined the call to be billable, the system gives the attending healthcare professional the right to waive the bill by overriding the billing sequence instructions. Decision box 19 includes the descriptive label “Waive Bill” for these aspects of the method.

In the event the attending healthcare professional exercises the option to waive the bill, the attending healthcare professional generates an appropriate signal to override the billing sequence in the system. Box 20 includes the descriptive label “Override Billing Logic” for this aspect of the method.

If decision box 19 indicates that the bill is not to be waived, the system server provides the billing data to the system database. The system then automatically transmits embedded credit card data to the attending healthcare professional's merchant account or generates an invoice for mailing on behalf of the attending healthcare professional to the requesting patient. Box 21 includes the descriptive label “Debit Patient” for these aspects of the method.

The system then provides the attending healthcare professional with the option to prepare dictation for transcription regarding the services rendered to the requesting patient. Decision box 22 includes the descriptive label “Transcription” for this decisional option by the attending healthcare professional. In the event the attending healthcare professional declines the option to dictate clinical notes regarding the services provided, the system recycles to box 4 to determine whether there are any telephone calls waiting in the queue requesting professional service by any of the attending healthcare professionals utilizing the system. Box 23 includes the descriptive label “Next Patient” for this aspect of the method.

In the event the attending healthcare professional has opted to provide dictation of clinical notes via telephone, the attending healthcare professional presses the asterisk button on the telephone, stays on the telephone line and dictates the clinical notes in response to a prompt. The notes are transcribed via a wave file and saved in the patient database forming a portion of the system database on the system server. The notes may be electronically transmitted to the attending healthcare professional or some third party for editing in accordance with a prior selected arrangement. Box 24 includes the descriptive label “Dictation” for these aspects of the method.

The attending healthcare professional then decides whether or not he or she wishes to make another call in response to any patient call which may be present in the queue in accordance with box 4. In the event the attending healthcare professional decides to make another such call, the system returns to box 5 to determine whether there is another call in the queue representing a requesting patient seeking medical service. Decision box 25 includes the descriptive label “Another Consultation” for these aspects of the method. If the attending healthcare professional decides to make another call, the system returns to box 5 as indicated by box 26 which includes the descriptive label “New Consultation” for this aspect of the method. Alternatively, if the attending healthcare professional decides to make no more calls at that time, the method terminates and Box 27 includes the descriptive label “Terminate Activity” for this aspect of the method.

### EXAMPLE

Patient Smith had agreed to participate in the process implicitly by selecting Dr. Jones as Patient Smith's physician. In the course of selecting Dr. Jones, patient Smith specified that patient Smith's payment method for telephone consultation with Dr. Jones would be by use of patient Smith's Mastercard number 1111-2222-3333-4444 for telephone consultations with Dr. Jones and would be by use of patient Smith's Visa card number 5555-6666-7777-8888 whenever patient Smith had an Internet-based consultation with Dr. Jones.

When patient Smith first selected Dr. Jones as patient Smith's physician, patient Smith told Dr. Jones that patient Smith had been diagnosed as having high blood pressure for which patient Smith was receiving a regimen of Sectrol and further suffered from seasonal allergies for which patient Smith took the antihistamine Zyrtec on a seasonal basis. These were the only medications patient Smith was taking. Patient Smith further provided his age, 55, gender as being male, marital status as being married, height as being 6′ tall, weight as being 195 lbs. and as having no known history of heart disease, diabetes or other relatively common medical problems frequently seen in upper middle age males. All of this information was entered into the database to establish patient Smith's parameters.

Patient Smith initiated the practice of the method for accounting and billing for telecommunicatively rendered services by making a telephone call to Dr. Jones' offices for consultation. When patient Smith called, the call was taken by a staff attendant in Dr. Jones' offices with the attendant capturing patient Smith's request.

When patient Smith called, Dr. Jones was busy having an office consultation with another patient. Accordingly, the staff attendant queried patient Smith as the reasons for patient Smith's call and was told that patient Smith was “depressed”. The staff attendant recognizing that a patient's self-diagnosis of depression could signal a very serious situation, assigned patient Smith as an “A” priority and placed patient Smith's information and an indicator that patient Smith had called into the call queue with a flag indicating that patient Smith was supposed to receive a return telephone call with the highest priority.

When Dr. Jones was finished with the patient he was seeing in his offices, Dr. Jones interrogated the call queue and saw that patient Smith had called and that the importance of returning patient Smith's call promptly was “high” as indicated by the “A” priority assigned to patient Smith's call.

From his position Dr. Jones had a display of the call queue on a video screen and moved the cursor on the screen thereby highlighting the individual calls resident in the call queue as physician Dr. Jones moved up and down the video screen. Seeing patient Smith's call and the “A” high priority assigned to that call for return, physician Dr. Jones clicked the data for patient Smith whereupon the computer system automatically dialed patient Smith's home telephone number. The computer system having the data, namely the telephone number, for patient Smith, automatically dials patient Smith and establishes a voice connection between physician Dr. Jones and patient Smith.

Since the captured patient request had already been checked against the patient database and patient Smith had been found to be within the database, when Dr. Jones' call was successfully connected to patient Smith, timing commenced. As Dr. Jones' telephone consultation with patient Smith preceded, the timer keeps track of the amount of time Dr. Jones consults with patient Smith. Once the consultation is ended and the telephone connection is broken, the timer stops. At that point, Dr. Jones is requested for a signal indication as to whether the consultation is billable or not. If Dr. Jones indicates, by the appropriate pushbutton on the telephone or key on the computer screen that the patient consultation is billable and further indicates that there is no reason to waive the bill, debit charged to patient Smith's Mastercard number 1111-2222-3333-4444 is generated. Additionally, physician Dr. Jones' comments regarding the consultation are recorded and saved to be transcribed or maintained for playback at a later date in the event that physician Dr. Jones needs to refresh his recollection regarding the consultation with patient Smith.

Dr. Jones, diagnosing patient Smith as being depressed, orders a prescription for Zoloft for patient Smith. The computer system responding to Dr. Jones' verbal instruction checks for drug interaction between the Zoloft which Dr. Jones has prescribed for patient Smith and the Sectrol and Zyrtec, which the database shows as patient Smith's current medications. Finding no unacceptable drug interaction between the Zoloft which Dr. Jones has prescribed for patient Smith and the Zyrtec and Sectrol, the system transmits the prescription to patient Smiths' selected pharmacy in order that patient Smith may pick up the prescription and begin the course of medication.

While the invention in its preferred manifestation and the best mode known for practice of the invention has been described, it is to be understood that the invention is not limited to the manner and mode described above but encompasses equivalents in the manner and mode described above as may be defined by the attached claims and equivalents thereto.

What is claimed:

1. A data collating, correlating and processing method for providing payments to providers rendering services individually and sequentially to patients via telecommunication means, based on individual timed service performances, third party guarantor-payors, comprising:
a. generating a display of visually discernable information corresponding to calls from patients seeking consultative service with said provider queued in accordance with a pre-established call priority scheme for call selection by a provider;
b. making a call to a patient selected by said provider by dialing a number corresponding to the selected queued call;
c. generating a display of patient medical history from said database and providing said display to a provider;
d. recording the length of completed calls as initiated by said provider;
e. computing a charge for each of said completed calls and entering information for such charge in the database for the called patient
f. recording the provider's voice generated clinical notes and instructions and entering those into the database indexed against the relevant patient;
g. providing a display of calls received, calls made and billings generated as a result thereof for inspection by said provider.

2. A method for accounting and billing for telephone and other remote service provision comprising the steps of.
a. collecting and collating data for a patient user to whom such services are to be rendered, said data including telephone and/or Internet contact specifications, payment mode(s) and account numbers and, optionally, patient insurance payment information and, independently optionally, patient service history and background;
b. in response to an asserted patient request for service comparing data provided by said asserted patient to said collected and collated data to determine whether said asserted patient is legitimate;
c. in the event the patient is determined to be non-legitimate, abandoning the current request for service and commencing processing a subsequent request for service;
d. upon verification of said asserted patient being legitimate as a result of said data comparison satisfying at least one preselected criterion, placing a marker respecting the patient's call in a ordered queue together with markers for other patient calls according to at least one preselected ordering protocol;
e. determining whether said request for service may satisfied without voice communication between said patient determined to be legitimate and said provider;
f. providing the requested service for said patient in the event provider voice communication is not required;
g. telecommunicatively attempting to connect said patient with a service provider of whom said patient has requested service be furnished via telecommunicative means;
h. upon failure to telecommunicatively connect said patient with said requested service provider, marking a record to memorialize the fact of attempted unsuccessful communication and commencing processing a subsequent request in said ordering queue for service;
i. upon successful telecommunicative connection of said patient with said requested service provider, maintaining such connection for a duration needed for the desired service to be provided
j. upon completion of service provision, updating data for the patient to reflect provision of the service and computing a charge for the service rendered during such time in accordance with instructions specified by the provider;
k. determining according to prespecified criteria whether the services provided during such time are chargeable;
l. if such services provided during such time are not chargeable, commencing processing the next request for service in such ordering queue;
m. if such services provided during such time are chargeable, eliciting provider input as whether a charge should be issued for such services;
n. if a charge is to be issued for such services, generating such charge according to preselected criteria which my include the length of time the patient and the provider were in telecommunicative contact and placing the generated charge data in the database marked for the patient to whom the services were rendered.

3. A method for providing payments to a provider rendering services individually and sequentially to a plurality of patients via telephone, based on the individual time duration for performance of said services, comprising the steps of:
a. collecting, collating and correlating into a machine-readable digital database individual data for a plurality of patients individually seeking personal services, said data including telecommunicative contact specifications, payment mode(s) and, optionally, payment guarantor account numbers;
b. in response to individual putative patient generated requests for service, electronically comparing data provided by said requesting putative patient to said collected and collated data to determine whether said putative patient is within said database;
c. upon finding said putative patient, and the putative patient is within said database, placing a telecommunicative request for service from such patient into an ordering queue according to at least one preselected ordering criterion;
d. telecommunicatively connecting said patient with a service provider by whom said patient has requested service be furnished;
e. upon conclusion of service, updating said database to reflect furnishing of the service and computing a charge for the service rendered based on, elapsed time for the provision of those services and optionally in accordance with any instructions received from the provider;
f. updating the database to reflect the generated charge for the patient to whom the services were rendered;
g. telecommunicatively furnishing said charge to the patient to a payment guarantor for said patient as identified in said database;
h. upon receipt of payment updating the database to reflect the degree of satisfaction of said generated charge by said patient or by any guarantor for said patient.
